(19) United States
(12) Patent Application Publication
(10) Pub. No.: US 2025/0237343 A1
(43) Pub. Date: Jul. 24, 2025

(54) DISPLAY MOUNT HAVING A ROTATION STOP

(71) Applicants: Thiem Chan Duong Wong et al., Brooklyn Park, MN (US); Jeffrey Randall Mensing, Eden Prairie, MN (US); Daniel Davis Anderson, Eagan, MN (US); Nathan Arlan Abel, Bloomington, MN (US); John William Theis, St. Paul, MN (US)

(72) Inventors: Thiem Chan Duong Wong et al., Brooklyn Park, MN (US); Jeffrey Randall Mensing, Eden Prairie, MN (US); Daniel Davis Anderson, Eagan, MN (US); Nathan Arlan Abel, Bloomington, MN (US); John William Theis, St. Paul, MN (US)

(21) Appl. No.: 18/977,472

(22) Filed: Dec. 11, 2024

Related U.S. Application Data
(60) Provisional application No. 63/622,274, filed on Jan. 18, 2024.

(51) Int. Cl. F16M 11/12; F16M 11/20

(52) U.S. Cl. CPC F16M 11/126; F16M 11/2035; F16M 2200/024; F16M 2200/065

(57) ABSTRACT

A display mounting system with an optional rotation stop is described. The display mounting system can include a pole coupled to a support structure and an arm assembly rotatably coupled to the pole. The arm assembly can include an first arm, a second arm, and a pivot adapted to receive an electronic display. A lock collar can be coupled to the pole to maintain the arm assembly at a desired elevation relative to the structure. The lock collar can also include rotation stops to limit a rotation of the arm assembly. A slider built into the arm assembly can be selectively activated to alternate a configuration of the arm assembly between a limited rotation configuration and a free rotation configuration. In the limited rotation configuration, the slider can cooperate with the rotation stops located on the lock collar to limit a rotation of the arm assembly.

### CLAIM OF PRIORITY

This patent application claims the benefit of priority of Wong, et al. U.S. Provisional Patent Application Ser. No. 63/622,274, entitled “DISPLAY MOUNT HAVING A ROTATION STOP,” filed on Jan. 18, 2024 (Attorney Docket No 5983.483PRV), which is hereby incorporated by reference herein in its entirety.

### TECHNICAL FIELD

This document pertains generally, but not by way of limitation, to systems and methods for mounting electronic displays on a structure.

### BACKGROUND

Display mounts can be used to couple one or more electronic displays (e.g., flat panel displays, tablets, or the like) to a structure (e.g., a table, a work surface, a wall, or the like). The display mount can include an articulating arm assembly coupled to the structure, a pivot assembly and a display interface. The display mount can improve workspace ergonomics by providing some articulation for the one or more electronic displays to change their orientation (e.g., the tilt angle, the rotation, or the height) relative to the structure.

### BRIEF DESCRIPTION OF THE DRAWINGS

The following drawings are illustrative of particular embodiments of the present invention and therefore do not limit the scope of the invention. The drawings are not to scale and are intended for use in conjunction with the explanations in the following detailed description. Like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a display mounting system according to an example configuration of the current disclosure.

FIG. 2 is a perspective view of a display mounting system according to another example configuration of the current disclosure.

FIG. 3 is a perspective view of a display mounting system according to yet another example configuration of the current disclosure.

FIG. 4 is an enlarged partial perspective view of the display mounting systems of FIGS. 1-3.

FIG. 5 is an enlarged partial perspective view of the first arm of FIGS. 1-3 according to an example configuration of the current disclosure.

FIG. 6 is a bottom view of the female coupling of the first arm of FIG. 5 according to an example configuration of the current disclosure.

FIG. 7 is a perspective view of a slider according to an example configuration of the current disclosure.

FIG. 8 is a top view of the slider of FIG. 7 according to an example configuration of the current disclosure.

FIG. 9 is an upper perspective view of a lock collar according to an example configuration of the current disclosure.

FIG. 10 is a lower perspective view of the lock collar of FIG. 9 according to an example configuration of the current disclosure.

FIG. 11 is a top cross-sectional view of the lock collar of FIG. 9 according to an example configuration of the current disclosure.

FIG. 12 is a cross-sectional side view of the display mounting system of FIG. 4 according to an example configuration of the current disclosure.

### OVERVIEW

This disclosure is directed to a display mounting system to mount one or more electronic displays (e.g., flat panel displays, tablets, or the like) to a structure (e.g., a table, a work surface, a wall, or the like). The display mounting system can include an articulating arm assembly having one or more display interfaces adapted to receive the one or more electronic displays. The articulating arm assembly can be coupled to the structure (e.g., via a clamp, or the like), and the articulating arm assembly can be used to change an orientation (e.g., the tilt angle, the rotation, or the height) of the one or more displays relative to the structure.

In some example configurations, the display mounting system can include a clamp having a base and a pole extending from the base in a transverse direction. The articulating arm assembly can be rotatably coupled to the pole.

The display mounting system can also include a lock collar. The lock collar can be slidably engaged with the pole, and the lock collar can be used to position the articulating arms assembly at a desired height from the base. The lock collar can also include rotation stops. The rotation stop can limit a rotation of the articulating arm assembly relative to the structure.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

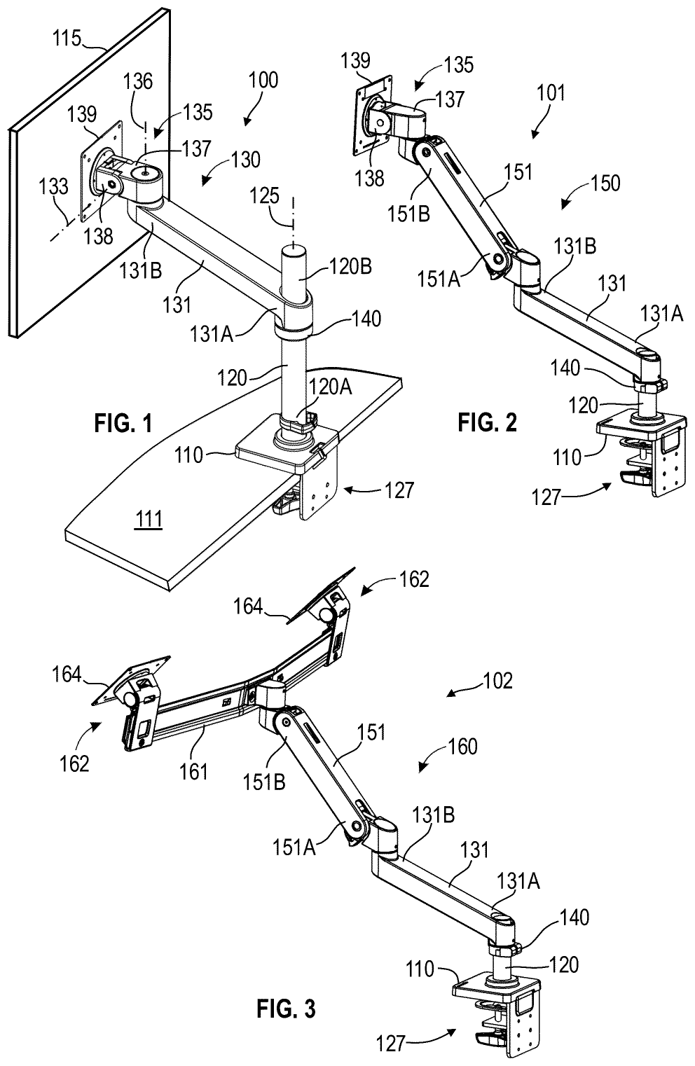

FIGS. 1-3 are perspective views of display mounting systems 100, 101, and 102 according to some example configurations of the current disclosure. The display mounting systems 100, 101, and 102 can implement various techniques of this disclosure.

The display mounting system 100 of FIG. 1 can include a base 110, a pole 120, and an arm assembly 130. The pole 120 can have a first portion 120A and a second portion 120B. The first portion 120A of the pole 120 can be coupled to the base 110, and the pole 120 can extend from the base 110 in a transverse direction towards the second portion 120B. The pole 120 can be made from any engineering material including, but not limited to, steel rod, steel tube, aluminum extrusion, cast aluminum, or the like.

In some example configurations, the base 110 can be placed over a structure 111 (e.g., a table surface, a work surface, or the like), and the base 110 can be coupled to the structure 111 via a clamp assembly 127. In other example configurations, the pole 120 can be directly coupled to a structure 111 (e.g., a surface, a wall, cabinet, or the like) via a mounting bracket (not shown).

The pole 120 can have a round cross-section. An axis of symmetry of the cross-section of the pole 120 can form the first axis 125. The first axis 125 can be in the longitudinal direction of the pole between the first portion 120A and the second portion 120B, and the first axis 125 can be generally in a vertical direction.

In some example configurations, the arm assembly 130 can include a first arm 131 having a first portion 131A and a second portion 131B. The first arm 131 can be rotatably coupled to the pole 120 proximate the first portion 131A. A pivot assembly 135 can be rotatably coupled to the first arm 131 proximate the second portion 131B. In other example configurations, a bow (e.g., the bow 161, shown in FIG. 3) can be rotatably coupled to the first arm 131 proximate to the second portion 131B. The bow can hold one or more pivot assemblies (e.g., the one or more tilt assemblies 162, shown in FIG. 3).

In some example configurations, the first arm 131 can have a fixed height (e.g., the second portion 131B can be at a set elevation from the first portion 131A). In other example configurations, the first arm 131 can be height adjustable (e.g., an elevation of the second portion 131B relative to the first portion 131A can be adjustable).

The pivot assembly 135 can include a pan bracket 137, a tilt bracket 138, and a display interface 139. The pan bracket 137 can be rotatably coupled to the first arm 131 about a second axis 136, and the tilt bracket 138 can be rotatably coupled to the pan bracket 137 about a third axis 133. The second axis 136 can be generally in a vertical direction and the third axis 133 can be perpendicular to the second axis 136 (e.g., the third axis 133 can be generally in a horizontal direction).

An electronic display 115 can be coupled to the display interface 139 to position the electronic display 115 relative to the structure 111 (e.g., position the electronic display over a work surface, or in front of a wall, or the like). The arm assembly 130 can be configured to translate the electronic display 115 (e.g., move, rotate, tilt, or the like) relative to the structure 111.

In some example configurations, the display mounting system 100 can also include a lock collar 140. The lock collar 140 can be slidably engaged with the pole 120. The lock collar 140 can be positioned at a desired height and rotation relative to the pole 120 anywhere along the length of the pole 120 between the first and the second portions 120A, 120B, and the lock collar 140 can be configured to clamp on the pole 120 (e.g., using a screw 200, shown in FIG. 11, or a lever, or the like). The first portion 131A of the first arm 131 can be adapted to rest on the lock collar 140 to position the first arm 131 at a desired height from the base 110, as illustrated in FIG. 1.

FIG. 2 is a perspective view of a display mounting system 101 according to another example configuration of the current disclosure. The display mounting system 101 can implement various aspects of the display mounting system 100 of FIG. 1. The display mounting system 101 can include a base 110, a pole 120, and an arm assembly 150. The display mounting system 101 can be coupled to a structure (e.g., coupled to the structure 111 of FIG. 1 via a clamp assembly 127).

The arm assembly 150 can include a first arm 131 having a first portion 131A and a second portion 131B, and a second arm 151. The second arm 151 can be elongated between a first portion 151A and a second portion 151B. The first portion 151A of the second arm 151 can be rotatably coupled to the second portion 131B of the first arm 131 and a pivot assembly 135 can be rotatably coupled to the second portion 151B of the second arm 151. In some example configurations, the second portion 151B of the second arm 151 can be configured to translate relative to the first portion 151A of the second arm 151 in a generally vertical direction. In other example configurations, the second portion 151B can be at a set elevation from the first portion 151A.

The pivot assembly 135 can include a pan bracket 137, a tilt bracket 138, and a display interface 139 similar to the pivot assembly 135 of FIG. 1, as discussed in previous sections. The display interface 139 can be adapted to receive an electronic display (e.g., the electronic display 115 of FIG. 1), and the display mounting system 101 can be configured to translate the electronic display 115 coupled to the display interface 139 relative to the structure.

FIG. 3 is a perspective view of a display mounting system 102 according to yet another example configuration of the current disclosure. The display mounting system 102 can implement various aspects of the display mounting systems 100, 101 of FIGS. 1-2. The display mounting system 102 can include a base 110, a pole 120, and an arm assembly 160. The display mounting system 101 can be coupled to a structure (e.g., coupled to the structure 111 of FIG. 1 via a clamp assembly 127).

The arm assembly 160 can include a first arm 131 having a first portion 131A and a second portion 131B, and a second arm 151. The second arm 151 can be elongated between a first portion 151A and a second portion 151B. The first portion 151A of the second arm 151 can be rotatably coupled to the second portion 131B of the first arm 131 and a bow 161 can be rotatably coupled to the second portion 151B of the second arm 151.

In some example configurations, the display mounting system 102 can include one or more tilt assemblies 162 having one or more display interfaces 164 adapted to receive one or more electronic displays (e.g., the electronic display 115 of FIG. 1). The one or more tilt assemblies 162 can be slidably engaged with the bow 161 to position electronic displays coupled to the one or more display interfaces 164 adjacent to each other. The display mounting system 102 can be configured to translate the one or more electronic displays coupled to the one or more display interfaces 164 relative to the structure.

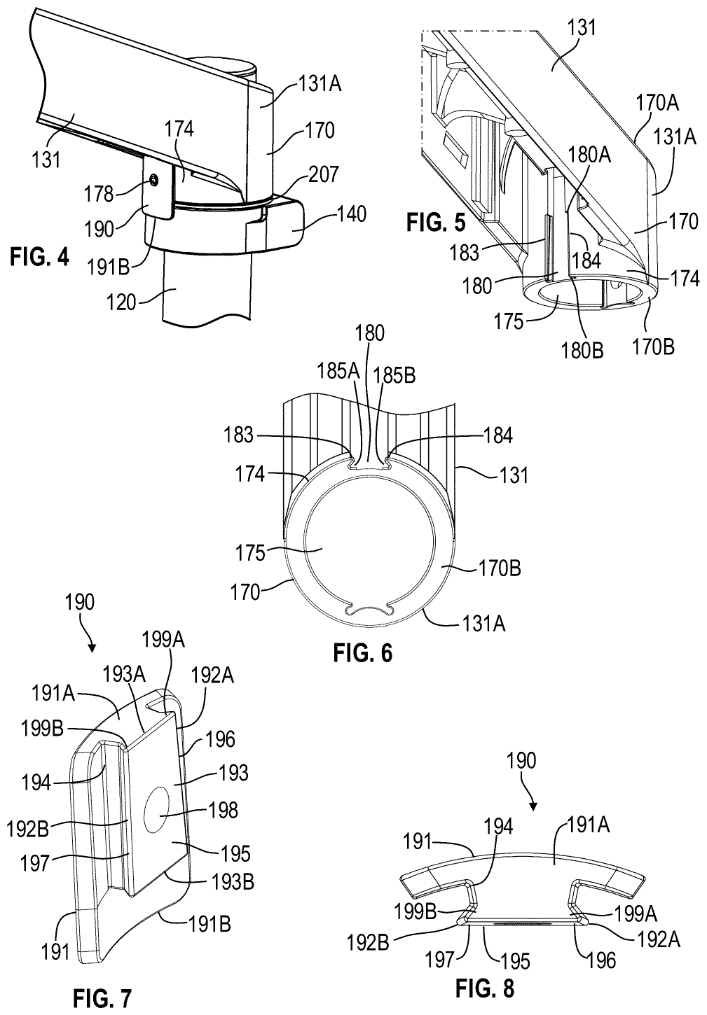

FIG. 4 is an enlarged partial perspective view of the display mounting systems 100, 101, and 102 of FIGS. 1-3 according to an example configuration of the current disclosure. A female coupling 170 can be built at the first portion 131A of the first arm 131. The female coupling 170 can have a first coupling end 170A and a second coupling end 170B opposite and away from the first coupling end 170A. The female coupling 170 can also have a side wall extending between the first coupling end 170A and the second coupling end 170B. The sidewall 174 can be located on an anterior side of the female coupling 170 (e.g., facing towards the second portion 131B of the first arm 131). The female coupling 170 can include an opening 175 extending through the female coupling 170 between the first coupling end 170A and the second coupling end 170B.

FIG. 5 is a partial perspective view of the first arm 131 according to an example configuration of the current disclosure. A cavity 180 can be formed on the sidewall 174 of the female coupling 170. The cavity 180 can extend between a first cavity end 180A proximate the first coupling end 170A and a second cavity end 180B proximate the second coupling end 170B. In some example configurations, the second cavity end 180B can coincide with the second coupling end 170B. The cavity 180 can have a first side 183 and a second side 184. A first recess 185A and a second recess 185B (shown in FIG. 6) can be formed on the first and the second sides 183, 184 of the cavity 180. In some example configurations, the first and the second recesses 185A, 185B can be formed in a V-shape.

Returning to FIG. 4, a slider 190 can be at least partially inserted into the cavity 180 and slidably engaged with the sidewall 174 of the female coupling 170. The slider 190 can be configured to translate between the first and the second cavity ends 180A, 180B. In some example configurations, the slider can extend away from the second coupling end 170B, as illustrated in FIG. 4. The slider 190 can be secured to the sidewall 174 at a desired location via a mechanical fastener 178 (e.g., a screw, or the like).

FIG. 6 is a bottom view of the female coupling 170 formed proximate to the first portion 131A of the first arm 131 of FIG. 5. The opening 175 can be formed in a circular cross-section, and the opening 175 can be adapted to receive the pole 120. The first arm 131 can be configured to rotate about the first axis 125 formed by the pole 120.

FIGS. 7-8 are perspective and top views of the slider 190 of FIG. 4 according to an example configuration of the current disclosure. The slider 190 can have a slider body 191. The slider body 191 can at least partially wrap around the sidewall 174 of the female coupling 170. The slider body 191 can be elongated between a first slider end 191A and a second slider end 191B opposite the first slider end 191A. A projection 193 having a first section 194 and a second section 195 can be formed on the slider 190. The first section 194 can be coupled to the slider body 191 and the projection 193 can extend from the slider body 191 in a transverse direction towards the second section 195.

The projection 193 can be elongated between a first projection end 193A proximate the first slider end 191A and a second projection end 193B proximate the second slider end 191B. The projection 193 can also have a first side 196 and a second side 197 opposite the first side 196. A first edge 192A and a second edge 192B can be formed on the first and the second sides 196, 197 proximate the second section 195. The first and second edges 192A, 192B can be elongated between the first projection end 193A and the second projection end 193B. The slider 190 can also include a threaded hole 198 proximate a center of the projection 193.

A first protrusion 199A and a second protrusion 199B can be formed on the first and the second edges 192A, 192B of the projection 193. The projection 193 can be at least partially located inside the cavity 180, and the first and the second protrusions 199A, 199B can be adapted to engage with the first and the second recesses 185A, 185B of the cavity 180 shown in FIG. 6. In some example configurations, the first and the second protrusions 199A, 199B can be formed in a V-shape.

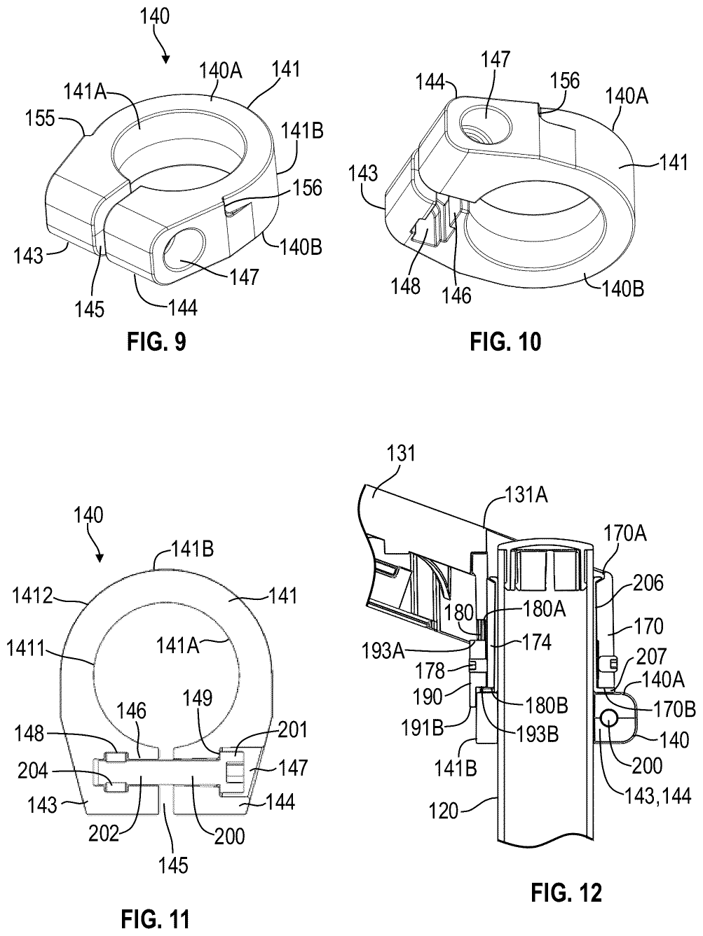

FIGS. 9-10 are perspective views of the lock collar 140 according to a configuration of the current disclosure. The lock collar 140 can include a collar body 141. The collar body 141 can be cylindrical for the most part. The lock collar 140 can have a first planar surface 140A and a second planar surface 140B opposite and away from the first planar surface 140A. The collar body 141 can have a cylindrical inner surface 141A and a generally cylindrical outer surface 141B each extending between the first and the second planar surfaces 140A, 140B. The cylindrical inner surface 141A can have a first diameter 1411 and the generally cylindrical outer surface 141B can have a second diameter 1412. In some example configurations, the cylindrical inner surface 141A and the cylindrical outer surface 141B can be concentric.

The lock collar 140 can also have a first lug 143 and a second lug 144. The first and the second lugs 143, 144 can project generally in a radial direction from the cylindrical outer surface 141B. The first and the second lugs 143, 144 can be slightly spaced apart forming a split 145 in the lock collar 140. The cylindrical inner surface 141A of the lock collar 140 can be configured to receive the pole 120 (shown in FIGS. 1-3). The first and the second lugs 143, 144 can provide bearing surfaces against which a clamping force can be applied to the lock collar 140 to push the first and the second lugs 143, 144 towards each other.

The lock collar 140 can have a locked configuration and an unlocked configuration. In the unlocked configuration, the lock collar 140 can be configured to freely translate along the pole 120 in parallel to the first axis 125 and rotate about the first axis 125 relative to the pole 120. By pushing the first and the second lugs 143, 144 towards each other (e.g., by tightening a screw 200 shown in FIG. 11), the lock collar 140 can be put in the locked configuration. In the locked configuration, the cylindrical inner surface 141A of the lock collar 140 can be adapted to press against the pole 120 to create a clamping force. The clamping force can immobilize the lock collar 140 relative to the pole 120 (e.g., the lock collar 140 cannot be translated or rotated relative to the pole 120) in the locked configuration.

In some example configurations, the lock collar 140 can include a slot 146 and an aperture 147 formed in the first and the second lugs 143, 144, respectively. The slot 146 can be aligned with the aperture 147. A pocket 148 can be formed in the slot 146. The pocket 148 can be adapted to receive a nut 204 (shown in FIG. 11). The aperture 147 can be generally in a round cross-section having a shoulder 149. The aperture 147 can be adapted to receive a screw 200 (shown in FIG. 11).

FIG. 11 is a top view of the lock collar 140. The lock collar 140 is rendered transparent for clarity in FIG. 11. A screw 200 having a screw head 201 and a threaded shaft 202 extending from the screw head 201 can be inserted through the aperture 147 such that the screw head 201 can rest against the shoulder 149. The threaded shaft 202 can extend from the second lug 144 into the slot 146 located in the first lug 143 and the threaded shaft 202 can threadedly engage with the nut 204. By turning the screw 200 relative to the nut 204, the first and the second lugs 143, 144 can be drawn together, thereby effectively reducing the first diameter 1411 of the cylindrical inner surface 141A of the lock collar 140. Reduction in the first diameter 1411 can increase the pressure applied to the pole 120 by the cylindrical inner surface 141A of the lock collar 140, and thereby, put the lock collar 140 in the locked configuration.

Returning to FIGS. 9-10, in some example configurations, the lock collar 140 can also include a first bump 155 and a second bump 156 formed on the cylindrical outer surface 141B proximate the first planar surface 140A of the lock collar 140. The first bump 155 can be located proximate to the first lug 143 and the second bump 156 can be located proximate to the second lug 144, as illustrated in FIG. 9.

FIG. 12 is a cross-sectional side view of the first portion 131A of the first arm 131 of FIG. 4. The female coupling 170 located in the first portion 131A of the first arm 131 can be placed on top of the lock collar 140 in a stacked-up orientation such that the opening 175 of the female coupling 170 and the cylindrical inner surface 141A of the lock collar 140 can be concentric. In the stacked-up orientation, the first planar surface 140A of the lock collar 140 can be across the second coupling end 170B.

The pole 120 can be inserted into the cylindrical inner surface 141A of the lock collar 140 and the opening 175 of the female coupling 170. A round bushing 206 having a flange 207 can be located in the opening 175 between the female coupling 170 and the pole 120. The flange 207 can be located between the second coupling end 170B and the first planar surface 140A, as illustrated in FIG. 12.

The display mounting systems, 101, and 102 can have a free rotation configuration and a limited rotation configuration. The slider 190 can optionally translate towards the first cavity end 180A or the second cavity end 180B to selectively put the display mounting systems, 101, and 102 in the free rotation configuration or the limited rotation configuration, respectively.

In the limited rotation configuration, the slider 190 can translate towards the second cavity end 180B, and the second projection end 193B (shown in FIG. 7) can be located proximate the second cavity end 180B (shown in FIG. 5), as illustrated in FIG. 12. In the limited rotation configuration, the second slider end 191B can extend away from the second coupling end 170B of the female coupling 170 towards the lock collar 140, as illustrated in FIGS. 4 and 12. The second slider end 191B can be adjacent the cylindrical outer surface 141B of the lock collar 140 (e.g., on the opposite side of the first lug 143 and the second lug 144, as illustrated in FIG. 12). The second slider end 191B can be located between the first bump 155 and the second bump 156, and the second slider end 191B can be free to rotate about the first axis 125 together with the first arm 131 between the first bump 155 and the second bump 156. A rotation of the first arm 131 can be limited in a first direction (e.g., in a counter-clockwise direction) when the second slider end 191B hits the first bump 155, and a rotation of the first arm 131 can be limited in a second direction opposite the first direction (e.g., in a clockwise direction) when the second slider end 191B hits the second bump 156.

In the unlocked configuration of the lock collar 140, the lock collar 140 can be rotated about the first axis 125 to orient the first bump 155 and the second bump 156 at a desired rotational orientation relative to the pole 120. When the lock collar 140 is in the locked configuration, the location of the first bump 155 and the second bump 156 can be fixed relative to the pole 120 (e.g., to define the desired rotation limits for the first arm 131 about the first axis 125). The first bump 155 and the second bump 156 can cooperate with the second slider end 191B to limit a rotation of the first arm 131 about the first axis 125 in a first direction and a second direction within the desired rotation limits defined by the first and the second bumps 155, 156, respectively.

In the free rotation configuration, the slider 190 can translate towards the first cavity end 180A such that the first projection end 193A can be located proximate the first cavity end 180A. In the free rotation configuration, the second slider end 191B can retract to the side of the female coupling 170 such that the second slider end 191B can be away from the first planar surface 140A (e.g., the second slider end 191B can be located by the sidewall 174 between the first and the second coupling ends 170A, 170B). In the free rotation configuration, the second slider end 191B can be away from the first and the second bumps 155, 156, and thereby, enabling the first arm 131 to rotate 360 degrees about the first axis 125 without any interruption.

### Additional Notes and Aspects

Example 1 is a display mounting system for mounting an electronic display to a structure, comprising: a pole elongated between a first portion and a second portion opposite the first portion, the first portion of the pole is couplable to the structure; an arm assembly rotatably coupled to the pole proximate to the second portion of the pole; a display mount operably coupled to the arm assembly, the display mount adapted to receive the electronic display; and a lock collar having a locked configuration and an unlocked configuration; wherein, in the locked configuration, the lock collar is configured to be immobilized relative to the pole to define a travel stop to limit a travel of the arm assembly between the first and second portions of the pole and a rotation stop to limit a rotation of the arm assembly about the pole, wherein, in the unlocked configuration, the lock collar is configured to be mobilized relative to the pole to selectively adjust the travel and the rotation stops for the arm assembly, wherein the arm assembly is configured to translate within the travel and rotation stops defined by the lock collar to translate the electronic display relative to the structure.

In Example 2, the subject matter of Example 1 optionally includes wherein the arm assembly comprises a first arm elongated between a first portion and a second portion, wherein the first portion of the first arm is rotatably coupled to the pole about a substantially vertical first axis.

In Example 3, the subject matter of Example 2 optionally includes wherein the display mounting system also comprises a pivot assembly comprising: a pan bracket rotatably coupled to the arm assembly about a substantially vertical third axis; and a tilt bracket rotatably coupled to the pan bracket on one end about a substantially horizontal fourth axis and coupled to the display mount on the other end.

In Example 4, the subject matter of any one or more of Examples 2-3 optionally include wherein the arm assembly comprises a second arm having a first portion and a second portion, wherein the first portion of the second arm is rotatably coupled to the second portion of the first arm about a substantially vertical second axis.

In Example 5, the subject matter of Example 4 optionally includes wherein the second portion of the second arm is configured to translate relative to the first portion of the second arm in a generally vertical direction.

In Example 6, the subject matter of any one or more of Examples 4-5 optionally include wherein the display mounting system also comprises a pivot assembly comprising: a pan bracket rotatably coupled to the arm assembly about a substantially vertical third axis; and a tilt bracket rotatably coupled to the pan bracket on one end about a substantially horizontal fourth axis and coupled to the display mount on the other end.

In Example 7, the subject matter of any one or more of Examples 1-6 optionally include a base coupled to the first portion of the pole; and a clamp assembly coupled to the base; wherein the clamp assembly is couplable to the structure to secure the base over the structure.

In Example 8, the subject matter of any one or more of Examples 2-7 optionally include wherein the first arm includes a female coupling having a first coupling end and a second coupling end formed proximate the first portion of the first arm; the female coupling comprises an opening extending through the female coupling between the first coupling end and the second coupling end, wherein the opening is adapted to receive the second portion of the pole, and the pole is at least partially located inside the opening to form the first axis, and wherein the first arm is configured to rotate relative to the pole about the first axis.

In Example 9, the subject matter of Example 8 optionally includes wherein a cavity is formed on the female coupling, the cavity comprises: a first cavity end; a second cavity end away from the first cavity end; a first side; and a second side opposite the first side; wherein the first and second sides are parallel to each other, and the first and the second sides extend between the first and the second cavity ends, and wherein a first recess and a second recess are formed on the first and the second sides, and the first and the second recesses extend at least a portion of the first and the second sides of the cavity.

In Example 10, the subject matter of Example 9 optionally includes wherein the first and the second recesses are formed in a V-shape.

In Example 11, the subject matter of any one or more of Examples 9-10 optionally include wherein the first arm includes a sidewall formed on an anterior side of the female coupling facing the second portion of the first arm, wherein the cavity is formed on the sidewall.

In Example 12, the subject matter of any one or more of Examples 9-11 optionally include wherein the second cavity end coincides with the second coupling end.

In Example 13, the subject matter of any one or more of Examples 9-12 optionally include a slider having a first slider end and a second slider end, the slider includes: a slider body elongated between the first slider end and the second slider end; and a projection coupled to the slider body, wherein the projection is elongated in parallel to the slider body between a first projection end proximate to the first slider end and a second projection end proximate to the second slider end; the projection comprising: a first section coupled to the slider body; a second section extending away from the slider body in a transverse direction; a first edge formed on a first side of the projection proximate the second section; a second edge formed on a second side opposite the first side of the projection proximate the second section, and a first and a second protrusions formed on the first and the second edges, the first and a second protrusions extends between the first projection end and the second projection end; wherein the projection is at least partially located inside the cavity and the first and the second protrusions of the projection are adapted to engage with the first and the second recesses of the cavity, and wherein the slider is configured to translate relative to the female coupling between the first cavity end and the second cavity end.

In Example 14, the subject matter of Example 13 optionally includes the slider also includes a threaded hole proximate to its center, wherein a mechanical fastener is threadedly engaged with the slider at the threaded hole, and wherein the mechanical fastener is adapted to press against the female coupling to immobilize the slider relative to the female coupling.

In Example 15, the subject matter of any one or more of Examples 13-14 optionally include wherein the first and the second protrusions are formed in a V-shape.

In Example 16, the subject matter of any one or more of Examples 13-15 optionally include a lock collar having a first planar surface and a second planar surface opposite the first planar surface, the lock collar comprises: a collar body including: a cylindrical inner surface having a first diameter; and a cylindrical outer surface having a second diameter; wherein the cylindrical inner and outer surfaces extend between the first and the second planar surface, a first lug and a second lug coupled to the collar body; and a first bump and a second bump formed on the cylindrical outer surface proximate the first planar surface of the lock collar; and wherein the first lug and the second lug extend from the cylindrical body in a radial direction, wherein the first lug and the second lug are located across each other separated by a split extending through the collar body between the first and the second planar surfaces, and wherein the cylindrical inner surface is adapted to receive the second portion of the pole.

In Example 17, the subject matter of Example 16 optionally includes the arm assembly also includes a round bushing having a flange extending from the round bushing in a radial direction, wherein the round bushing is located between the female coupling of the first arm and the pole, and wherein the flange is configured to be located between the second coupling end of the female coupling and the first planar surface of the lock collar.

In Example 18, the subject matter of any one or more of Examples 16-17 optionally include wherein the lock collar includes an unlocked configuration and a locked configuration, wherein the lock collar is freely translatable along the pole and freely rotatable relative to the pole in the unlocked configuration, wherein the lock collar is stationary relative to the pole in the locked configuration, wherein, in the locked configuration, the lock collar is adapted to support the arm assembly and the one or more electronic displays coupled to the arm assembly in vertical direction and adapted to limit a rotation of the first arm about the first axis.

In Example 19, the subject matter of Example 18 optionally includes wherein the lock collar also comprises a slot formed on the first lug and an aperture formed on the second lug, wherein a pocket formed on the first lug is adapted to receive a nut, wherein a screw having a screw head and a threaded shaft is inserted through the aperture such that the screw head rests against a shoulder formed on the second lug and the threaded shaft extends into the slot to threadedly engage with the nut, wherein the first lug and the second lug are adapted to move towards each other by turning the screw relative to the nut, and thereby, causing a reduction in the first diameter of the cylindrical inner surface of the lock collar to apply a pressure against the pole to put the lock collar in the locked configuration.

In Example 20, the subject matter of any one or more of Examples 18-19 optionally include wherein the arm assembly includes a limited rotation configuration and a free rotation configuration, wherein the slider is configured to optionally translate relative to the cavity towards the second cavity end such that the second slider end extends out of the cavity towards the lock collar proximate the cylindrical outer surface of the lock collar between the first bump and the second bump to put the first arm in the limited rotation configuration, wherein, in the limited rotation configuration, the second slider end is adapted to contact either the first bump or the second bump of the lock collar to limit a rotation of the first arm relative to the pole about the first axis, wherein the slider is configured to optionally translate relative to the cavity towards the first cavity end such that the second slider end retracts into the cavity to put the first arm in the free rotation configuration, wherein, in the free rotation configuration, the second slider end does not contact the first bump or the second bump of the lock collar, and thereby, enabling the first arm to rotate 360 degrees relative to the pole about the first axis.

Each of these non-limiting examples can stand on its own or can be combined in any permutation or combination with elements of any one or more of the other examples.

The above-detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls. The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about”.

What is claimed is:

1. A display mounting system for mounting an electronic display to a structure, comprising:
a pole elongated between a first portion and a second portion opposite the first portion, the first portion of the pole is couplable to the structure;
an arm assembly rotatably coupled to the pole proximate to the second portion of the pole;
a display mount operably coupled to the arm assembly, the display mount adapted to receive the electronic display; and
a lock collar having a locked configuration and an unlocked configuration;
wherein, in the locked configuration, the lock collar is configured to be immobilized relative to the pole to define a travel stop to limit a travel of the arm assembly between the first and second portions of the pole and a rotation stop to limit a rotation of the arm assembly about the pole,
wherein, in the unlocked configuration, the lock collar is configured to be mobilized relative to the pole to selectively adjust the travel and the rotation stops for the arm assembly,
wherein the arm assembly is configured to translate within the travel and rotation stops defined by the lock collar to translate the electronic display relative to the structure.

2. The display mounting system of claim 1, wherein the arm assembly comprises a first arm elongated between a first portion and a second portion, wherein the first portion of the first arm is rotatably coupled to the pole about a substantially vertical first axis.

3. The display mounting system of claim 2, wherein the display mounting system also comprises a pivot assembly comprising:
a pan bracket rotatably coupled to the arm assembly about a substantially vertical third axis; and
a tilt bracket rotatably coupled to the pan bracket on one end about a substantially horizontal fourth axis and coupled to the display mount on the other end.

4. The display mounting system of claim 2, wherein the arm assembly comprises a second arm having a first portion and a second portion,
wherein the first portion of the second arm is rotatably coupled to the second portion of the first arm about a substantially vertical second axis.

5. The display mounting system of claim 4, wherein the second portion of the second arm is configured to translate relative to the first portion of the second arm in a generally vertical direction.

6. The display mounting system of claim 4, wherein the display mounting system also comprises a pivot assembly comprising:
a pan bracket rotatably coupled to the arm assembly about a substantially vertical third axis; and
a tilt bracket rotatably coupled to the pan bracket on one end about a substantially horizontal fourth axis and coupled to the display mount on the other end.

7. The display mounting system of claim 1, further comprising:
a base coupled to the first portion of the pole; and
a clamp assembly coupled to the base;
wherein the clamp assembly is couplable to the structure to secure the base over the structure.

8. The display mounting system of claim 2, wherein the first arm includes a female coupling having a first coupling end and a second coupling end formed proximate the first portion of the first arm; the female coupling comprises an opening extending through the female coupling between the first coupling end and the second coupling end,
wherein the opening is adapted to receive the second portion of the pole, and the pole is at least partially located inside the opening to form the first axis, and
wherein the first arm is configured to rotate relative to the pole about the first axis.

9. The display mounting system of claim 8, wherein a cavity is formed on the female coupling, the cavity comprises:
a first cavity end;
a second cavity end away from the first cavity end;
a first side; and
a second side opposite the first side;
wherein the first and second sides are parallel to each other, and the first and the second sides extend between the first and the second cavity ends, and
wherein a first recess and a second recess are formed on the first and the second sides, and the first and the second recesses extend at least a portion of the first and the second sides of the cavity.

10. The display mounting system of claim 9, wherein the first and the second recesses are formed in a V-shape.

11. The display mounting system of claim 9, wherein the first arm includes a sidewall formed on an anterior side of the female coupling facing the second portion of the first arm, wherein the cavity is formed on the sidewall.

12. The display mounting system of claim 9, wherein the second cavity end coincides with the second coupling end.

13. The display mounting system of claim 9, further comprising a slider having a first slider end and a second slider end, the slider includes:
a slider body elongated between the first slider end and the second slider end; and
a projection coupled to the slider body, wherein the projection is elongated in parallel to the slider body between a first projection end proximate to the first slider end and a second projection end proximate to the second slider end; the projection comprising:
a first section coupled to the slider body;
a second section extending away from the slider body in a transverse direction;
a first edge formed on a first side of the projection proximate the second section;
a second edge formed on a second side opposite the first side of the projection proximate the second section, and
a first and a second protrusions formed on the first and the second edges, the first and a second protrusions extends between the first projection end and the second projection end;
wherein the projection is at least partially located inside the cavity and the first and the second protrusions of the projection are adapted to engage with the first and the second recesses of the cavity, and
wherein the slider is configured to translate relative to the female coupling between the first cavity end and the second cavity end.

14. The display mounting system of claim 13, the slider also includes a threaded hole proximate to its center,
wherein a mechanical fastener is threadedly engaged with the slider at the threaded hole, and
wherein the mechanical fastener is adapted to press against the female coupling to immobilize the slider relative to the female coupling.

15. The display mounting system of claim 13, wherein the first and the second protrusions are formed in a V-shape.

16. The display mounting system of claim 13, further includes a lock collar having a first planar surface and a second planar surface opposite the first planar surface, the lock collar comprises:
a collar body including:
a cylindrical inner surface having a first diameter; and
a cylindrical outer surface having a second diameter;
wherein the cylindrical inner and outer surfaces extend between the first and the second planar surface,
a first lug and a second lug coupled to the collar body; and
a first bump and a second bump formed on the cylindrical outer surface proximate the first planar surface of the lock collar; and
wherein the first lug and the second lug extend from the cylindrical body in a radial direction,
wherein the first lug and the second lug are located across each other separated by a split extending through the collar body between the first and the second planar surfaces, and
wherein the cylindrical inner surface is adapted to receive the second portion of the pole.

17. The display mounting system of claim 16, the arm assembly also includes a round bushing having a flange extending from the round bushing in a radial direction,
wherein the round bushing is located between the female coupling of the first arm and the pole, and
wherein the flange is configured to be located between the second coupling end of the female coupling and the first planar surface of the lock collar.

18. The display mounting system of claim 16, wherein the lock collar includes an unlocked configuration and a locked configuration,
wherein the lock collar is freely translatable along the pole and freely rotatable relative to the pole in the unlocked configuration,
wherein the lock collar is stationary relative to the pole in the locked configuration,
wherein, in the locked configuration, the lock collar is adapted to support the arm assembly and the one or more electronic displays coupled to the arm assembly in vertical direction and adapted to limit a rotation of the first arm about the first axis.

19. The display mounting system of claim 18, wherein the lock collar also comprises a slot formed on the first lug and an aperture formed on the second lug,
wherein a pocket formed on the first lug is adapted to receive a nut,
wherein a screw having a screw head and a threaded shaft is inserted through the aperture such that the screw head rests against a shoulder formed on the second lug and the threaded shaft extends into the slot to threadedly engage with the nut,
wherein the first lug and the second lug are adapted to move towards each other by turning the screw relative to the nut, and thereby, causing a reduction in the first diameter of the cylindrical inner surface of the lock collar to apply a pressure against the pole to put the lock collar in the locked configuration.

20. The display mounting system of claim 18, wherein the arm assembly includes a limited rotation configuration and a free rotation configuration,
wherein the slider is configured to optionally translate relative to the cavity towards the second cavity end such that the second slider end extends out of the cavity towards the lock collar proximate the cylindrical outer surface of the lock collar between the first bump and the second bump to put the first arm in the limited rotation configuration,
wherein, in the limited rotation configuration, the second slider end is adapted to contact either the first bump or the second bump of the lock collar to limit a rotation of the first arm relative to the pole about the first axis,
wherein the slider is configured to optionally translate relative to the cavity towards the first cavity end such that the second slider end retracts into the cavity to put the first arm in the free rotation configuration,
wherein, in the free rotation configuration, the second slider end does not contact the first bump or the second bump of the lock collar, and thereby, enabling the first arm to rotate 360 degrees relative to the pole about the first axis.
